(19) United States
(12) Patent Application Publication
(10) Pub. No.: US 2009/0171899 A1
(43) Pub. Date: Jul. 2, 2009

(54) ONE-STOP TRAVEL SEARCH

(75) Inventors: Arjun CHITTOOR, Hyderabad (IN); Sudhir Shenoy, Bangalore (IN)

Correspondence Address: MORRISON & FOERSTER LLP, 425 MARKET STREET, SAN FRANCISCO, CA, 94105-2482, US

(73) Assignee: YAHOO! INC., Sunnyvale, CA (US)

(21) Appl. No.: 11/966,701

(22) Filed: Dec. 28, 2007

(51) Int. Cl. G06F 17/30

(52) U.S. Cl. 707/3; 707/E17.014

(57) ABSTRACT

One-stop travel search technology operable to aid users via an improved graphical information display is disclosed. The one-stop travel search technology can be operable to display a graph of the price of the travel mode depending on variables such as time of day. In one embodiment, the one-stop travel search technology further displays information pertaining to travel prices from online travel agents along with those directly obtained from the travel service providers. The technology accesses a travel event database, and directs display of information relating to the travel event based on the event information.

### FIELD OF THE INVENTION

The present invention relates generally to internet information search, and more particularly to search and presentation of travel information.

### BACKGROUND OF THE INVENTION

The convenience of various modes of travel such as air travel, bus, train, tram, etc. depends on several factors such as departure point, departure time, choice of carrier (e.g., airline, cruise line), travel class and ticket price. Travel class is usually split into a two, three, or four class model such as economy class, premium economy, business class or club class, and first class. The price of an economy class ticket and a first class ticket are often extremely different, with prices for a first class ticket being more expensive. The time of travel is also an important determining factor for price, and travel at convenient times is often more expensive, such as after the end of the workday.

Travel tickets are increasingly being purchased on web pages on the internet such as YAHOO! TRAVEL. There are generally three ways of searching and booking tickets online. First are Online Travel Agents (OTA), examples of which are WWW.TRAVELOCITY.COM in the United States, and WWW.YATRA.COM in India. Here, the user directly visits the OTA site and inputs the specifics of the user's intended travel (e.g., source, destination, dates), and then views displayed information for different airlines with their time of departure and fares. These fares may vary among the OTAs based on their relationships and commitment with the airline companies, and the displayed fares are usually sorted by price. The user may use the displayed information only for fare discovery or may go ahead and make a travel booking. The travel booking is usually done on the OTA site itself.

The second of the three general ways of searching and booking tickets online are travel meta-search products. For example, WWW.KAYAK.COM is a meta-search site in the United States, and IN.FARECHASE.YAHOO.COM is a meta-search site in India. Here, the user visits the meta-search site, which collects the required information from airlines based upon user-generated input values, and then displays the results, usually sorted by fare. On clicking a preferred choice, the user is re-directed to the airline website where the booking is performed.

The third of the three general ways of searching and booking tickets online is to do so directly on the airlines websites, for example WWW.SOUTHWEST.COM in the United States, and WWW.JETAIRWAYS.COM in India. The user visits one or more airline websites and directly books the ticket according to the user's preferences.

FIG. 1 is a screen shot illustrating a current method of presenting travel information on a travel web page 100. The key components for deciding the choice of flights are price 102, departure time 104, and arrival time 106. For a given user input, most search results default to sorting by price 102, but can also be sorted by departure time 104 and arrival time 106. An example of this is shown in FIG. 1 illustrating search results from a travel website. The lowest priced fare between New Delhi and Bangalore is at a 6:15 hrs (24 hour time) departure time, the second lowest priced fare is at 6:45 hrs, 11:00 hrs, and 13:10 hrs, the third lowest is at 9:00 hrs, the fourth lowest at 20:00 hrs, and so on. In this example, the user can travel to Bangalore only after office hours at 5 pm (17:00 hrs), so he/she is looking for the cheapest fares after 5 pm. When a user sorts by price, he/she has to focus until he/she reaches the cheapest flight after 5 pm. If the user sorts by departure time, he/she has to look at all prices after 5 pm and not the first flight that he/she sees in order to check for fares. This may not be the optimal way for a user to discover an optimal flight.

FIG. 2 shows a screen shot of another current method of presenting travel information on a travel web page. This method is known as “Sliders”. In the Sliders method, the time of day 202 may be adjusted by the user by sliding slide 204, and as the slide 204 is moved, the travel price at that time is displayed 206. The Sliders require human action for filtering results.

These methods require an active effort by the user to sort or filter the information presented to him or her. In particular, when a large number of flights and flight times are listed, the user may need to spend considerable time to determine an optimal flight for his/her needs. Therefore, there is a need for systems and methods that improve the ease of determining and/or purchasing an optimal travel ticket.

### SUMMARY OF THE INVENTION

One-stop travel search technology operable to aid users via an improved graphical information display is disclosed. The one-stop travel search technology can be operable to display a graph of the price of the travel mode depending on variables such as time of day. In one embodiment, the one-stop travel search technology further displays information pertaining to travel prices from online travel agents along with those directly obtained from the travel service providers. The technology accesses a travel event database, and directs display of information relating to the travel event based on the event information.

A first embodiment comprises an online one-stop travel search system. The system may include a user search interface module for receiving a travel plan, such as location of departure/arrival, time of departure/arrival, number of passengers, and travel class corresponding to a travel mode (e.g., air travel, rail travel, or travel by ship) from a user.

The system may also include a first search engine module (e.g., an online travel agent search engine) for searching and obtaining a first set of online travel results from a first set of online travel sources (e.g., online travel agents websites) in response to the travel plan, and processing logic for providing display information used in creating a travel results graph corresponding to the first online travel results. The travel results graph includes a ticket price axis to show a range of ticket prices, a travel time axis to show a range of travel times, and a travel line graph to show the ticket prices as a function of the travel times (e.g., time of departure, or time of arrival).

The system may also include a second search engine module (e.g., a meta-search engine module) for obtaining a second set of online travel results (e.g., original travel results) directly from a second set of online travel sources (e.g., travel service provider websites).

The system may also include a correlator module for associating the first set of online travel results with the second set of online travel results, and provide for display the first set of online travel results along with the second set of online travel results. The travel line graph includes a plurality of icons to provide network links to travel details corresponding to each of the ticket prices.

A second embodiment comprises an online one-stop travel search method. The method may include receiving a travel plan corresponding to a travel mode, searching and obtaining a first set of online travel results from a first set of online travel sources in response to the travel plan, and constructing and displaying a travel results graph corresponding to the first set of online travel results. The travel results graph includes a ticket price axis to show a range of ticket prices, a travel time axis to show a range of travel times, and a travel line graph to show the ticket prices as a function of the travel times. The method may further search and obtain a second set of online travel results directly from a second set of online travel sources, and correlate the first set of online travel results with the second set of online travel results. The method also provides for display of the first set of online travel results along with the second set of online travel results.

A third embodiment comprises an interface for an online one-stop travel search. The interface provides for display of a travel results graph to show a ticket price axis which shows a range of ticket prices, a travel time axis which shows a range of travel times, and a travel line graph for showing ticket prices as a function of travel times on the travel results axis. The ticket prices are within the range of ticket prices, and the travel times are within the range of travel times. The interface may also show a travel results comparison table for presenting a first set of travel data obtained from a first set of online travel sources along with a second set of travel data obtained from a second set of online travel sources.

A fourth embodiment comprises a system for one-stop travel search. The system may include a user search interface module for receiving travel choices from the user, and modify behavior of the user search interface module based on the travel choices received from the user, a first search engine module for searching and obtaining a first set of online travel results from a first set of online travel source websites, in response to the travel choices. The systems may also include: a second search engine module for searching and obtaining a second set of online travel results, in response to the travel choices, form a second set of online travel sources, a correlator module for associating the first set of online travel results with the second set of online travel results to obtain a travel results comparison table, and provide for display the travel results comparison table and a travel results graph.

A fifth embodiment comprises a computer-readable medium comprising program code for executing an on line one-stop travel search. The program code may include code for receiving travel choices corresponding to a travel mode from a user. The program code also include searching for and obtaining a first set of online travel data from a first set of online travel sources in response to the travel choices, and constructing a travel result graph corresponding to the first set of online travel data. The program code may also include code for searching for and obtaining a second set of online travel data from a second set of online travel sources in response to the travel choices, and correlating the first set of online travel data with the second set of online travel data to obtain a travel results comparison table. The program code may also include code for providing for display the travel results graph and the travel results comparison table.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and shall not be considered limiting of the breadth, scope, or applicability of the disclosure. It should be noted that for clarity and ease of illustration these drawings are not necessarily made to scale.

FIG. 1 is an illustration of an exemplary travel web page of a current travel web site.

FIG. 2 is an illustration of an exemplary slider user interface of a travel web page of a current travel web site.

FIG. 3 is a block diagram illustrating an exemplary one-stop travel search system in accordance with an embodiment of the present disclosure.

FIG. 4 is an illustration of an exemplary one-stop travel search user interface showing a travel results graph according to an embodiment of the present disclosure.

FIG. 5 is an illustration of an exemplary one-stop travel search user interface showing a travel results graph and a travel results comparison table according to another embodiment of the present disclosure.

FIG. 6 shows an exemplary flow diagram illustrating an exemplary one-stop travel search process in accordance with an embodiment of the present disclosure.

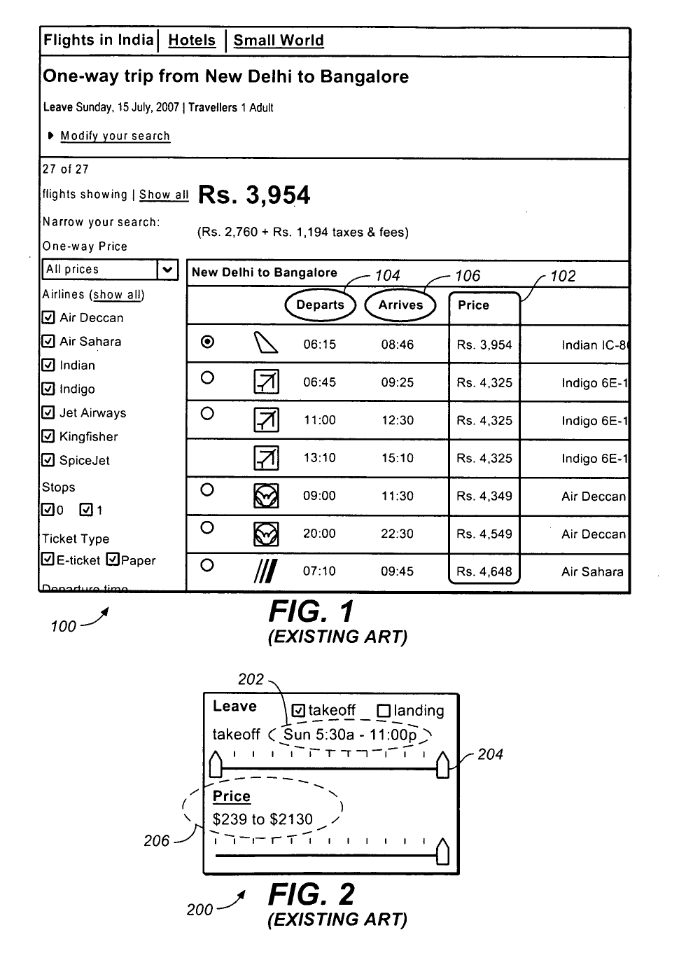

### DETAILED DESCRIPTION OF THE PREFERRED EMBODIMENT

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

In the following description of preferred embodiments, reference is made to the accompanying drawings which form a part hereof, and in which it is shown by way of illustration specific embodiments in which the disclosure may be practiced. It is to be understood that other embodiments may be utilized and structural changes may be made without departing from the scope of the preferred embodiments of the present disclosure.

The present disclosure is directed toward systems and methods for providing a one-stop travel search. Embodiments of the invention are described herein in the context of one practical application, namely, air travel planning and purchase of an airline ticket. In this context, the example system is applicable to provide information and procedures for pricing and purchasing airline tickets. Embodiments of the invention, however, are not limited to such air travel applications, and the methods described herein may also be utilized in other applications such as rail travel, sea cruises, or ferry boats. As would be apparent to one of ordinary skill in the art after reading this description, these are merely examples and the invention is not limited to operating in accordance with these examples.

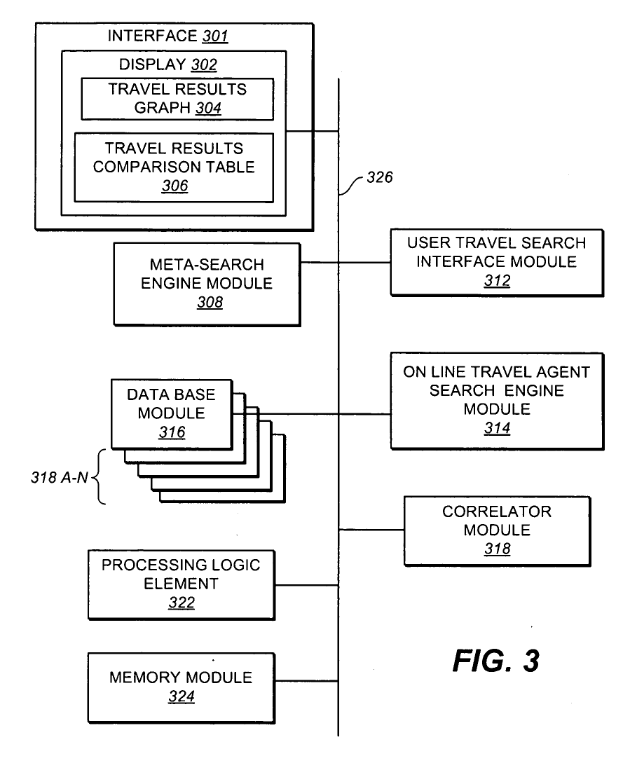

FIG. 3 illustrates a one-stop travel search system 300 that may be employed to implement processing functionality in embodiments of the disclosure. System 300 may be used to provide travel time and price information to aid users via an improved graphical information display according to an embodiment of the present disclosure. Those skilled in the relevant art will also recognize how to implement the invention using other systems or architectures. System 300 may represent, for example, a desktop, a laptop or a notebook computer, a hand-held computing device (PDA, cell phone, palmtop, etc.), mainframe, server, client, or any other type of special or general purpose computing device as may be desirable or appropriate for a given application or environment. System 300 may include: an interface 301, a meta-search engine module 308, a user search interface module 312, a database module 316, an online travel agent search engine module 314, a correlator module 318, one or more processing logic elements 322, and a memory module 324. Various elements of the one-stop travel search system 300 may communicate via a communications network 326 such as the Internet.

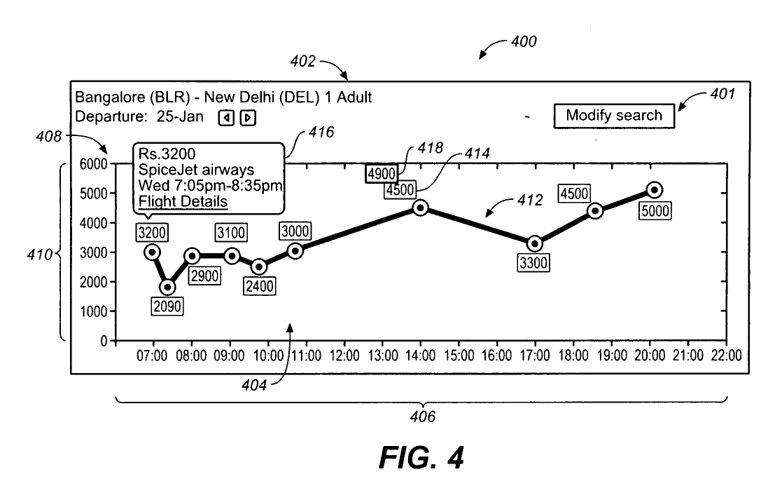

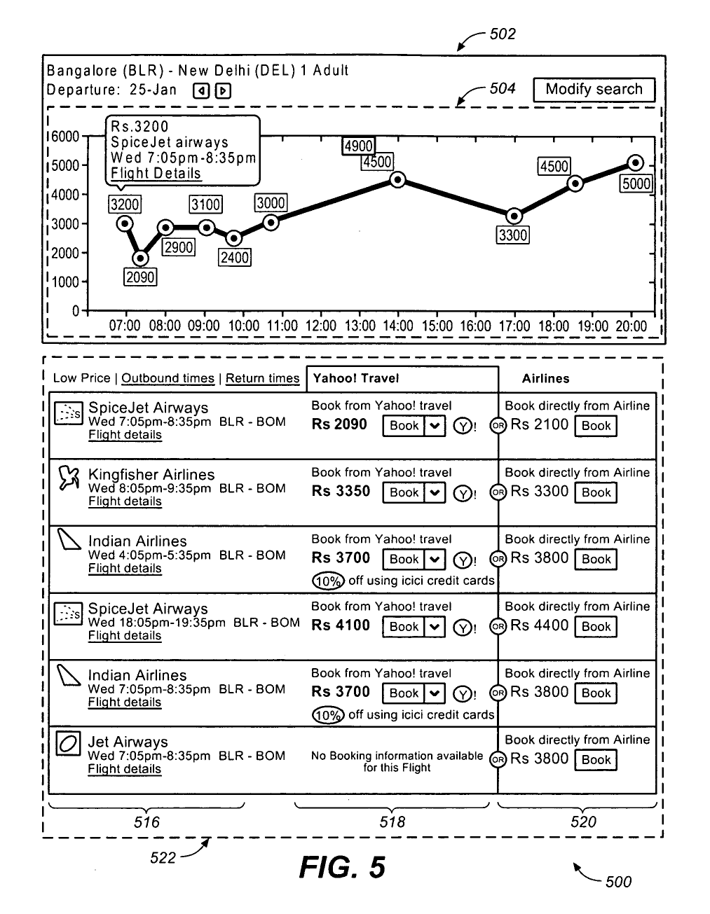

The interface 301 includes a display 302. According to an embodiment of the discloser, the display 302 includes a comparison table 306 and a travel result graph 304 as explained in more detail in the context of FIGS. 4-5 below. Display 302 is configured to show information for a travel mode. The travel mode may comprise air travel, rail travel, travel by ship or other travel methods. The display may be on a computer web page, kiosk, travel agent computer terminal, mobile device, or other forms of information presentation. The display 302 may be coupled to databases on a server such as, for example, those of an Online Travel Agent (OTA) or airline websites to obtain travel search results.

The online travel agent (OTA) 314 is configured to obtain OTA travel results from service providers in response to the travel choices as explained in more detail above.

Meta-search engine module 308 may be configured to query/obtain original travel results directly from travel service providers in response to travel choices of the end user. The meta-search engine collects the flight rates directly from the travel service providers' (e.g., airlines) websites as explained in more detail above.

The user travel search interface module 312, is configured to prompt the user for travel plans such as a destination/departure pair. The user travel search interface module 312 may be configured to prompt a user for travel choices, receive the user's choice of itinerary, and modify behavior of the user travel search interface module 312 based on the travel choice selections received from the user. The user travel search interface module 312, may be configured to identify the flight and flight schedule and tailor responses to the requester. The user travel search interface module 312 may be a YAHOO! TRAVEL interface module, or the like. In one embodiment, the user travel search interface module 312 may be configured to query the user for her/his choices of travel plan itinerary and direct the user to search the database 316 for an acceptable fare price (i.e., in most cases the cheapest fare price) in response to the choice of the itinerary as explained below. The itinerary may include departure/arrival location, departure/arrival time, number of passengers, travel class, and the like. For example, in one embodiment, the system 300 can prompt for a flight time, ticket price, departure point, destination point, travel class, or other information that might be used to identify the flight. The responses can be numeric or alpha-numeric—for example, via a keypad. According to one embodiment, the user interface module 312 may operate to search remote or locally stored databases as explained below.

Database module 316 is configured to store travel data pertaining to the travel choice selections received from the user. The travel data may include, travel time, ticket prices, point of departure, point of arrival, name of travel service provides, an the like. The database module 316 may operate on one or more computers, servers, workstations, or other data gathering, processing, computing and reporting. Database module 316 may also include data storage, record keeping and retrieval capabilities. Database module 316 can include one or more databases 318A-318N (where N represents total number of databases) to store the various data and other information used in the one-stop travel search system 300. Although separate database units are illustrated, data storage can be across any physical or logical data storage architecture, and any of a number of database models can be implemented. In one embodiment, a relational database structure is used to facilitate creation of responses from various separate sources of data. In a further embodiment the database module 316 may be configured to reference and retrieve the travel departure and arrival airport information, and input information concerning a plurality of travel departure and arrival geography ranges. In one embodiment, the database module 316 may be associated with remote storage libraries, sources accessible via the Internet, or the like, as well as locally stored databases.

The correlator module 318 is configured to correlate the original travel results with the online travel agent (OTA) results to obtain a travel results comparison table 306. The meta-search engine results may be juxtaposed against the internal OTA flight price results after the meta-search engine 308 collects the flight rates directly from the travel service providers' (e.g., airlines) websites. The travel results comparison table 306 is obtained by juxtaposing values such as airline names, flight prices, and flight times for comparison. This may be done with an internal process or an external service such as FARECHASE.YAHOO.COM. For example, the meta-search engine captures flight name (INDIAN AIRLINES) and flight time (4:05 pm) then the OTA obtains the fares for the same combination (of flight name and time) from YAHOO! TRAVEL and displays them next to each other as shown and described in more detail below in the context of FIG. 5.

Processing logic element 322, is configured to execute instructions pertaining to operation of the one-stop travel search system 300 as described herein, such as retrieving data from the database 316 to construct the travel results graph 302, communicating with the correlator module 318 to perform instructions for constructing the travel results comparison table 306, and providing for display information for displaying the travel results graph 302 and the travel results comparison table 306. The processing logic element 322 can be implemented using a general or special purpose processing engine such as, for example, a microprocessor, microcontroller, or other control logic. In this example, the processing logic element 322 may be coupled to the elements of system 300 via the communications network 326.

The memory module 324, may be coupled to database module 318 and the processing logic element 322 and is configured to store travel results, user choices, data pertaining to construction of the travel results graph 302 and the travel results comparison table 306, and the like. The memory module 324 may be a random access memory (RAM) or other dynamic memory, for storing data in a database that pertains to the travel choice selections received from the user. Memory module 324 also may be used for storing instructions to be executed by processing logic element 322, and for storing temporary variables or other intermediate information during execution of instructions to be executed by processing logic element 322. The memory module 324 may include a read only memory (“ROM”) or other static storage device coupled to the communications network 326 for storing static information and instructions for the processing logic elements 322.

The one-stop travel search system 300 can be a centralized facility, or any or all of its various functions can be distributed across a plurality of facilities or locations in a geographically diverse manner. Further, the various functions described herein as attributable to one-stop travel search system 300 can be distributed to and among the various facilities it services.

A motivation of this disclosure is to provide the user an easier and more efficient way to discover an optimal airline and departure or arrival time for her or his preferred choice of departure time and destination based on available ticket prices and available departure or arrival times. FIG. 4 illustrates an exemplary one-stop travel search user interface 400 is configured to provide available travel time and ticket price data to aid end-users selecting a fare via an improved graphical information display according to one embodiment of this disclosure. The one-stop travel search system 400 may share some components, features, and functionality with one-stop travel search system 300, and such common aspects will not be redundantly described in detail with respect to one-stop travel search user interface 400. The user interface 400 may include a display 402, a travel results graph including a travel time axis 404, a travel ticket price axis 408, and a travel line graph 412 presented on the display 402.

A travel time axis 404 is presented on the display 402 to show a range of travel times 406. The range of travel times 406 comprises dates and/or times of relevance to the user's choice of itinerary. For example, a user may need to travel to a city B anytime between 6 am and 10 am. The user may look at the travel time axis 304 to see the range of available travel times 406 for traveling to the city B. In FIG. 4, the travel timeline 404 is shown on a horizontal axis, but it could be on a vertical axis or in another form of presentation. The travel time axis 404 may indicate departure time or arrival time, or other travel time indication.

A ticket price axis 408 is added to the display to show a range of available ticket prices 410. The range of available ticket prices 410 may be based on a range of available ticket prices provided by travel service providers queried based on the end-user's choice of itinerary. In FIG. 4, the travel price indicator 408 is shown on a vertical axis, but it could be on a horizontal axis or in another form of presentation.

Travel line graph 412 presents a way to identify the optimum flight based on the end-user's criteria. The travel line graph 412 shows ticket prices 414 as a function of travel time 406 based on the end-user choice of destination/arrival (e.g., Bangalore to New Delhi) and travel times (e.g., arrival/departure). The key advantages to this travel line graph 412 is that the graphical display of travel results such as ticket price and departure time or arrival time gives a quicker, user friendly way to visually discover the optimal flight. For example, an end-user may need to travel to New Delhi anytime between 1:00 pm (13:00) and 11 pm but he/she can look at the travel line graph and quickly realize that most of the cheap flights are available before 12 pm. In one embodiment, the ticket price icon 414 may be displayed about the travel line graph 412 and may be configured to provide a network link to the travel details. The user may click on the ticket price icon 414 to see the travel details 416 such as name of the airline, time and travel date, ticket price, and the like. The use may activate the link to the travel details by clicking on the ticket price icon 414 via a mouse or by touching the ticket price icon 414 on the screen, or other activation methods. On a mobile device, a stylus or other activation methods might be used instead of a mouse. Notably, in one embodiment, ticket prices icons 414 and 418 may overlap if, for example, in rare situations, two flights from two airlines are departing or arriving at a same time to or from a same location. In accordance with another embodiment of the disclosure, if the user does not discover an acceptable ticket, he/she may redo the search by clicking the mouse on the “modify search” link 401. The user may then be redirected to the travel search interface module 312.

As described above the booking on an online travel agent site (e.g., WWW.TRAVEXXX.COM) usually begins with the display of search results with the ticket price as per the agreement with the airline. For example, an OTA may have a bulk booking deal with airline A so the OTA may get a X % discount on the airline listed price for the same flight listed on the OTA's site (here the OTA prices for the same ticket are cheaper than those at the airline's site). An airline may prefer to have cheaper fares listed on the airline site and may charge a slight premium to the OTA (i.e., the airline website shows cheaper fares than the OTA site), or an OTA may not even have a relationship with a particular airline A. In this case, the airline results may not even show up on the OTA listings. Many users intend to first see the OTA results and then verify the prices (of the cheapest price discovered) by going to the airline website. This involves two separate searches by the user, one on the OTA website and the other on the airline website. Another embodiment of this disclosure combines both results to show the price offered by the airline and the price offered by the OTA on one webpage as explained in more detail below in the context of FIG. 5.

FIG. 5 illustrates an exemplary one-stop travel search user interface 500 configured to provide travel time and price information to aid users via an improved graphical information display according to a further embodiment of the present disclosure. The one-stop travel search user interface 500 may share some components, features, and functionality with one-stop travel search user interface 300-400, and such common aspects will not be redundantly described in detail with respect to one-stop travel search user interface 500. The user interface 500 may include a display 502, and a travel results graph 504 on the display. These functions are similar to the one-stop travel search interface 400, as explained in the context of FIG. 4 above, however, the one-stop travel search user interface 500 shown in FIG. 5 may be additionally configured to display a travel results comparison table 522 as explained below.

The travel results comparison table 522 includes travel service provider names 516, the ticket prices obtained from OTA 518, and the original ticket prices obtained directly from the travel service provider web service 520. The travel service provider names 516 may be airlines such as KINGFISHER AIRLINES, JET AIRWAYS, INDIAN AIRLINES, SPICEJET AIRWAYS, and the like. The ticket prices from OTA 518 for each airline are presented, along with the ticket prices from the travel service provider web service 520. The display of flight schedule with ticket prices along with the prices available from the original airline website saves the user the time of cross checking and discovering fares from the original airline website.

Compared to system 400, system 500 comprises two features: 1) a graphical display of results using ticket price and departure/arrival time giving a quicker, user friendly way to visually discover the optimal flight (see FIG. 4), and 2) a comparison table 522 to display flight schedule and OTA prices along with the prices available on the original airline website at that point in time saving the user the time of cross checking and discovering fares from the original airline site.

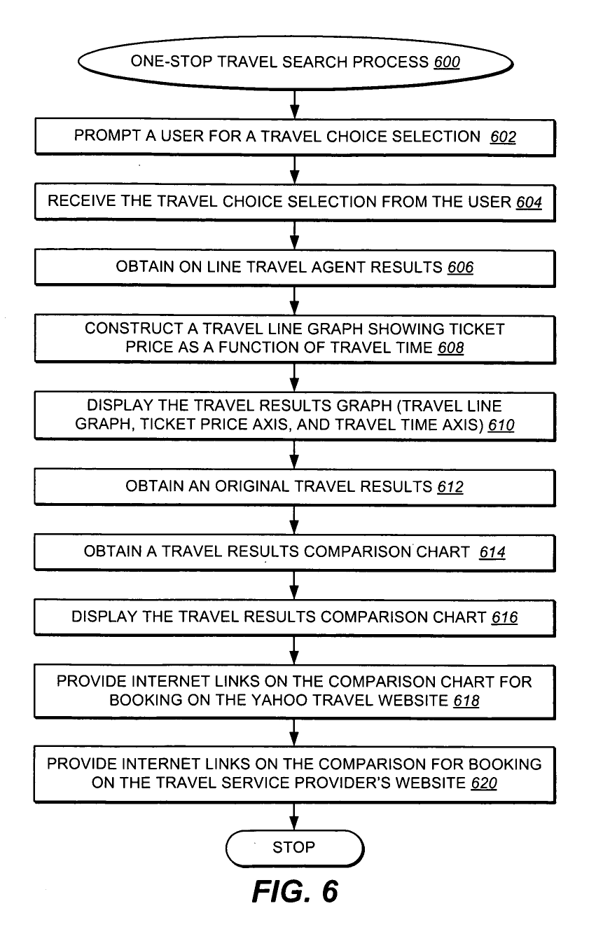

FIG. 6 is an illustration of an exemplary flow diagram of a one-stop travel search process 600 according to an embodiment of the present disclosure. The various tasks performed in connection with process 600 may be performed by software, hardware, firmware, a computer-readable medium having computer executable instructions for performing the process method, or any combination thereof. It should be appreciated that process 600 may include any number of additional or alternative tasks, the tasks shown in FIG. 6 need not be performed in the illustrated order, and process 600 may be incorporated into a more comprehensive procedure or process having additional functionality not described in detail herein. For illustrative purposes, the following description of process 600 may refer to elements mentioned above in connection with FIGS. 3-5. In various embodiments, portions of process 600 may be performed by different elements of systems and methods 300-500, e.g., interface including: display, travel time axis, travel price axis, range of travel prices and travel times, travel line graph, user travel search interface module, database module, OTA search engine module, meta-search engine module, correlator module, processing logic element, and the memory module.

The one-stop travel search process 600 may begin by prompting a user for travel plan/travel choice selection (task 602). The travel choice may include location of departure, location of arrival, time of departure, number of passengers, flight class, time of arrival, and the like.

Process 600 then receives the travel choice selection from the user (task 604) and proceeds to obtain the travel results in response to the travel choices of the user (task 606). The travel results, for example, may include ticket prices at corresponding travel times for a destination/departure pair selected by the user. In one embodiment, process 600 may obtain the travel results provided by travel service providers via an OTA engine (task 608) as explained above in the context of FIG. 4. Process 600 accesses an OTA database, and based on the user's travel choices/plan, searches for the corresponding travel results. As described above booking on an online travel agent site usually begins with the display of search results with the price as per the agreement with the airlines.

Process 600 then constructs a travel results graph (task 608) to present the travel results (e.g., ticket prices and travel times) corresponding to a travel mode such as air travel, rail travel, or travel by ship. The travel results graph includes a ticket price axis to show a range of ticket prices, a travel time axis to show a range of travel times, and a travel line graph to show the travel times as a function of the ticket prices within their respective ranges. The travel price axis indicates a range of travel prices. The range of travel times comprises dates and/or times of relevance to the user. For example, a user may need to travel to a station B anytime between 6 am and 10 am. The user may look at the travel time axis to see the range of travel times to the station B. The travel time axis may indicate departure time or arrival time, or other travel time indication. To make the search for an acceptable flight more intuitive for the user an easy graph with time of departure/arrival along the horizontal axis and the ticket prices price along the vertical axis is used as shown in FIGS. 4-5 above. However, a graph with time of departure/arrival along the vertical axis and the ticket prices along the horizontal axis may also be displayed. The travel line graph may also include price quotes and provide links via the price quote to the travel details as explained above in the context of FIG. 4.

Process 600 then provides for display of the travel time axis, the travel price axis, the travel line graph, and the travel price quote (task 610). The graphical display of results using ticket price and departure time or arrival time gives a quicker, user-friendly way to visually discover the optimal flight (see FIGS. 4). For example, the user has to travel after 16:00 hrs, and a quick glance at the travel results graph shows that INR 3300 is the cheapest fare after 16:00 hrs. A “mouse over” that price would give the details as shown in FIG. 4 above. For another example, the user is OK to travel anytime on the cheapest fare, and a quick look tells him/her that that the cheapest price she/he can get is INR 2090 at about 7:30 am.

In one embodiment, process 600 may also obtain original travel results (task 614) directly from travel service providers in response to the travel choices, and associate the original travel results with the OTA travel results to obtain a travel result comparison table (task 614) as explained in the context of FIG. 5 above. Process 600 then presents the travel results comparison table on the display (task 616). The travel results comparison table displays flight schedule and OTA prices along with the prices available on the original airline website at that point in time saving the user the time of cross checking and discovering fares from the original airline site. For example, a user wanting to travel by the INDIAN AIRLINES flight (see FIG. 5) can see the original airline price and compare to the OTA airline price without having to go to the airline website and may find out that it's best to book on YAHOO! TRAVEL. So, the user clicks on the “book from Yahoo travel” link (task 618) and completes the booking on the YAHOO! TRAVEL website. For another example, the user chooses to travel by KINGFISHER and sees that the airline price is cheaper than offered by YAHOO! TRAVEL via OTA so the user clicks on the “book directly from the airline” link and completes the booking on the airline website. (YAHOO! TRAVEL may make money for the lead). For another example, the user wants to book the Jet airways flight but YAHOO! TRAVEL as an OTA does not have a relationship with JETAIRWAYS. So, the user clicks on the “book directly from the airline” link and completes the booking on the airline website (task 620) (YAHOO! TRAVEL may make money for the lead).

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the disclosure, whether or not such embodiments are described and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skilled in the art, two or more modules may be combined to form a single module that performs the associated functions according embodiments of the present disclosure.

In this document, the terms “computer program product”, “computer-readable medium”, and the like may be used generally to refer to media such as, for example, memory module 324, or database module 316. These and other forms of computer-readable media may be involved in storing one or more instructions for use by processing logic element 322 to cause the processing logic element 322 to perform specified operations. Such instructions, generally referred to as “computer program code” (which may be grouped in the form of computer programs or other groupings), when executed, enable the system 300 to perform features or functions of embodiments of the present disclosure. Note that the code may directly cause the processor to perform specified operations, be compiled to do so, and/or be combined with other software, hardware, and/or firmware elements (e.g., libraries for performing standard functions) to do so.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements or controllers may be performed by the same processing logic element or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. An online one-stop travel search system, comprising:
a user search interface module for receiving a travel plan from a user, wherein the travel plan corresponds to a travel mode;
a first search engine module for searching for and obtaining a first set of online travel results from a first set of online travel sources in response to the travel plan; and
processing logic for providing display information used in forming a travel results graph corresponding to the first set of online travel results.

2. The online one-stop travel search system of claim 1, further comprising a second search engine module for obtaining a second set of online travel results from a second set of online travel sources.

3. The online one-stop travel search system of claim 2, further comprising a correlator module for associating the first set of online travel results with the second set of online travel results.

4. The online one-stop travel search system of claim 3, wherein the display is further operable to present the first set of online travel results along with the second set of online travel results.

5. The one-stop travel search system of claim 3, further comprising a database module for storing data pertaining to the travel plan, the first set of online travel results and the second set of online travel results.

6. The online one-stop travel search system of claim 1, wherein the travel results graph comprises:
a ticket price axis showing a range of ticket prices;
a travel time axis showing a range of travel times; and
a travel line graph showing ticket prices as a function of travel times, wherein the ticket prices are within the range of ticket prices, and the travel times are within the range of travel times.

7. The online one-stop travel search system of claim 6, wherein the travel line graph further comprises a plurality of icons, wherein the icons are operable to provide network links to travel details corresponding to each of the ticket prices.

8. The online one-stop travel search system of claim 6, wherein the travel time axis indicates departure time.

9. The online one-stop travel search system of claim 6, wherein the travel time axis indicates arrival time.

10. The online one-stop travel search system of claim 1, wherein the travel mode comprises air travel, rail travel, or travel by ship.

11. The online one-stop travel search system of claim 1, wherein the travel plan comprises location of departure, location of arrival, time of departure, time of arrival, number of passengers, and travel class.

12. A method for online one-stop travel search, the method comprising:
receiving a travel plan from a user;
searching a first set of online travel sources for a first set of online travel results in response to the travel plan;
obtaining the first set of online travel results from the first set of online travel sources;
constructing a travel results graph corresponding to the first set of online travel results; and
providing for display of the travel results graph.

13. The online one-stop travel search method of claim 12, further comprising:
searching a second set of online travel sources for a second set of online travel results in response to the travel plan;
obtaining the second set of online travel results from the second set of online travel sources; and
providing for display of the first set of online travel results along with the second set of online travel results.

14. The online one-stop travel search method of claim 13, further comprising correlating the first set of online travel results with the second set of online travel results.

15. The one-stop travel search method of claim 14, further comprising storing data pertaining to the travel plan, the first set of online travel results and the second set of online travel results.

16. The online one-stop travel search method of claim 12, wherein the travel results graph comprises:
a range of ticket prices on a ticket price axis;
a range of travel times on a travel time axis; and
a travel line graph showing ticket prices as a function of travel times, wherein the ticket prices are within the range of ticket prices, and the travel times are within the range of travel times.

17. The online one-stop travel search method of claim 16, further comprising linking the travel results graph to travel details corresponding to each of the ticket prices.

18. An interface for an online one-stop travel search, the interface comprising:
a travel results graph operable to show:
a ticket price axis for illustrating a range of ticket prices;
a travel time axis for illustrating a range of travel times; and
a travel line graph for illustrating ticket prices as a function of travel times,
wherein the ticket prices are within the range of ticket prices, and the travel times are within the range of travel times; and
a travel results comparison table.

19. The interface of claim 18, wherein the travel line graph further comprises a plurality of icons for providing network links to travel details corresponding to each of the ticket prices.

20. The interface of claim 18, wherein the travel results compassion chart shows a first set of travel data obtained from a first set of online travel sources along with a second set of travel data obtained from a second set of online travel sources.

21. An online one-stop travel search system, comprising:
a user search interface module for receiving travel choices from the user, and modify behavior of the user search interface module based on the travel choices received from the user;
a first search engine module for searching for and obtaining a first set of online travel results from a first set of online travel sources in response to the travel choices;
a second search engine module for searching for and obtaining a second set of online travel results in response to the travel choices;
a correlator module for associating the first set of travel results with the second set of travel results to obtain a travel results comparison table; and
processing logic for providing for display of the travel results comparison table and a travel results graph.

22. The online one-stop travel search system of claim 21, wherein the travel results graph comprises:
a range of ticket prices on a first axis;
a range of travel times on a second axis; and
a travel line graph showing ticket prices as a function of travel times, wherein the ticket prices are within the range of ticket prices, and the travel times are within the range of travel times.

23. A computer-readable medium for providing an online one-stop travel search, the program code for:
receiving travel choices from a user;
searching a first set of online travel sources for a first set of online travel data in response to the travel choices;
obtaining the first set of online travel data from the first set of online travel sources;
constructing a travel results graph corresponding to the first set of online travel data; and
providing for display of the travel results graph.

24. The computer-readable medium of claim 23, further comprising:
searching a second set of online travel sources for a second set of online travel data in response to the travel choices;
obtaining the second set of online travel data from the second set of online travel sources;
correlating the first set of online travel data with the second set of online travel data to obtain a travel results comparison table; and
providing for display of the travel results comparison table.

25. The computer-readable medium of claim 23, wherein the travel results graph comprises:
a range of ticket prices on a first axis;
a range of travel times on a second axis; and
a travel line graph showing ticket prices as a function of travel times, wherein the ticket prices are within the range of ticket prices, and the travel times are within the range of travel times.
